(19) United States
(12) Patent Application Publication
(10) Pub. No.: US 2005/0049895 A1
(43) Pub. Date: Mar. 3, 2005

(54) Automobile failure prevention support method and system

(75) Inventor: Tomomi Kasahara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/939,436

(22) Filed: Sep. 14, 2004

Related U.S. Application Data
(63) Continuation of application No. PCT/JP02/03129, filed on Mar. 28, 2002.

(51) Int. Cl. G06F 17/60

(52) U.S. Cl. 705/1

(57) ABSTRACT

An automobile failure prevention support service method for providing support for prevention of automobile failures to registered users, wherein: the degrees of deterioration of items such as expendables and oils and automotive parts designated as periodic automobile inspection items are stored for all automobiles in a general-purpose table in corresponding relationship to traveled distance thereof; for each user, data about items such as expendables and oils and automotive parts to be inspected on the user's automobile is stored in an automobile management table, along with maintenance and repair history thereof; each time the user's automobile travels a predetermined distance or each time the automobile undergoes maintenance or inspection at a service factory, the total distance so far traveled by the automobile is input and data thereof is stored in the automobile management table; a determining device searches the automobile management table based on the stored traveled-distance information and determines whether or not there is any part that needs checking or any item that needs servicing or replacing and, if there is any part that needs checking or any item that needs servicing or replacing, the automobile user is notified accordingly.

### CROSS-REFERENCE TO RELATED APPLICATIONS

This application is a continuation application of PCT/JP02/03129, filed on Mar. 28, 2002, the contents being incorporated herein by reference.

### TECHNICAL FIELD

The present invention relates to an automobile failure prevention support method and system, and particularly to a support service and system for preventing automobile failures occurring due to the deterioration of expendable parts, oils, etc. of the automobile. More specifically, the invention relates to an automobile failure prevention support method and system wherein provisions are made to perform inspections of expendable parts, oils, etc. of the automobile in accordance with the traveled distance of the automobile, rather than performing such inspections at prescribed intervals of time such as at the time of periodic check maintenance or at the time of mandatory vehicle inspection.

### BACKGROUND ART

Automobiles designed to be driven on public roads are widely used by the general public, and it is desirable from the point of view of effective and economical utilization that automobiles do not run into trouble while traveling on the road. It is also desirable that automobiles do not cause a public nuisance, such as air pollution, by exhaust gas emission. One reason is that, if an automobile runs into trouble while traveling on a public road and becomes inoperative, for example, the automobile stopped on the public road hampers the traffic of other automobiles traveling on the road, causing traffic congestion and sometimes leading to an accident such as a collision. Another reason is that if air pollution is caused by exhaust gas emissions, damage is caused to the public health. It is therefore desirable that automobiles be periodically maintained in order to keep the exhaust gas clean and to prevent failures.

On the other hand, though automobile drivers have a driving license, many of them have little knowledge about the mechanisms of automobiles, and do not know what to do when their automobiles run into trouble. Therefore, periodic inspection and maintenance is indispensable in order to ensure safe and effective utilization of automobiles.

Specifically, in Japan, it is required by the Road Vehicles Act that parts vital to vehicle safety be checked, maintained, and inspected regularly, and the following maintenance system is employed.

(1) Automobile users are required to perform or receive periodic inspection and maintenance, such as pre-departure checkups and periodic check maintenance.

(2) Safety standards for road vehicles are provided, requiring automobile users to receive conformance checks such as new vehicle inspection, mandatory periodic inspection (vehicle inspection), and overhaul inspection.

Automobiles except commercial automobiles are required to undergo the periodic check maintenance every year and the mandatory periodic inspection three years after new vehicle registration and every two years thereafter.

However, even when the periodic maintenance of automobiles is made mandatory, if the maintenance/inspection timing is specified in terms of period (time) such as every one year or two years, as in Japan, there arises the problem that the failure rate differs among automobiles because the degree of deterioration of each expendable part differs depending on the distance traveled during that period. That is, in the case of an automobile whose traveled distance is relatively short, it will be effective to perform inspection and maintenance at predetermined intervals of time, because the degree of deterioration of expendable parts is small and the failure rate is low; on the other hand, in the case of an automobile whose traveled distance is large, the degree of deterioration of expendable parts is large and the failure rate is high, the resulting problem being an increased probability of the automobile suffering a failure before the predetermined inspection timing arrives.

There has also been the problem that, in the event of automobile trouble, many users cannot judge whether the trouble is of the degree that can be repaired at a filling station or of the degree that the user has to ask the dealer's service factory or the like to repair.

### DISCLOSURE OF THE INVENTION

Accordingly, it is an object of the present invention to provide an automobile failure prevention support service method and system wherein, rather than simply performing inspection and maintenance of an automobile at predetermined intervals of time, periodic inspection and maintenance are performed as they become necessary in consideration of the actual degree of deterioration of expendable parts, etc. related to the traveled distance of the automobile, thereby achieving effective and economical utilization of the automobile while preventing a public nuisance such as air pollution caused by exhaust gas emissions, and wherein provisions are made to be able to even notify the user of the automobile of the site where the necessary periodic inspection and maintenance can be received.

It is another object of the invention to enhance user convenience by making provisions to notify the owner of the automobile of the maintenance timing based on the degree of deterioration of expendable parts, etc. related to the traveled distance of the automobile, and to provide useful information to the user, for example, recommending a service factory, in accordance with a “maintenance needed/not needed response” from the notified user.

It is a further object of the invention to reduce the number of times of maintenance the user has to receive and the cost involved, by making provisions so that, when notifying the user of the presence of the part or parts that need servicing, it is also checked whether there is any other part that will need servicing in the near future and, if there is any such part, the user of the automobile is also notified of the presence of such a part.

According to a first aspect of the invention that achieves the above objects, there is provided an automobile failure prevention support service method for providing support for prevention of automobile failures to registered users, wherein: a general-purpose table is created which stores the degrees of deterioration of automotive parts and expendables in corresponding relationship to maintenance timing; an automobile management table specific to each user registered with the service is created which stores data about parts and expendables of the user's automobile along with maintenance history thereof; a determination is made as to whether or not there is any part that needs checking or any item that needs servicing or replacing, by checking the automobile management table against the general-purpose table based on the stored maintenance history; and if there is any part that needs checking or any item that needs servicing or replacing in the user's automobile, the user of the automobile is notified accordingly.

In a method according to a second aspect which refers back to the method of the first aspect, the automobile management table also stores information such as the address and contact number of the user, the model name, type, and model year of the automobile, and the name and address of a dealer where the automobile was purchased.

In a method according to a third aspect which refers back to the method of the second aspect, if there is any part that needs checking or any item that needs servicing or replacing, the automobile management table is searched once again to check whether there is any other part or item for which checking, servicing, or replacement timing is expected to arrive within a predetermined travel distance as counted from current total distance traveled, and information including the result of the search is sent to the contact number of the automobile user.

In a method according to a fourth aspect which refers back to the method of the second or third aspect, a maintenance site management table is further created which stores information concerning maintenance sites on a nationwide scale along with information describing automobile inspection and maintenance items and the capability of each individual maintenance site to perform automobile maintenance or repair that matches each automobile model or type; if there is any part that needs checking or any item that needs servicing or replacing in the user's automobile, an inquiry is sent to the contact number of the user, inquiring whether the user desires to have the automobile checked and serviced; if the user desires to have the automobile checked and serviced, a search is made for a maintenance site that can perform the needed maintenance or repair; and information about the maintenance site searched for is sent to the contact number of the automobile user.

In a method according to a fifth aspect which refers back to the method of the fourth aspect, if a response is received from the automobile user desiring to have the automobile checked and serviced, a further inquiry is sent to the contact number of the user, inquiring whether the user desires to have the automobile checked and serviced immediately; if a response is received from the user desiring to have the automobile checked and serviced immediately, the current position of the automobile is detected; a search is made through the automobile management table within a predetermined distance range from the current position of the automobile to locate a nearby maintenance site that can perform the inspection and maintenance of the automobile, and information about the located maintenance site is sent to the contact number of the automobile user; if a response is received from the user desiring to have the automobile checked and serviced but not immediately, a table in which maintenance sites are stored in association with the address of the user is referred to; and a search is made for a maintenance site located within a predetermined distance range from the address of the user and capable of performing the inspection and maintenance of the automobile, and information about the maintenance site searched for is sent to the contact number of the automobile user.

In a method according to a sixth aspect which refers back to the method of any one of the first to fifth aspects, the maintenance history of the automobile is entered into the automobile management table at a filling station each time the automobile stops for refueling or at a maintenance site at which the maintenance has been performed.

According to a first aspect of the invention that achieves the above objects, there is provided an automobile failure prevention support service system for providing support for prevention of automobile failures to users registered with a service center, comprising: an intercommunication mechanism interlinking the service center, automobile maintenance and repair sites, and the registered users; a first storage device having a general-purpose table in which, for each automobile model and type, the degrees of deterioration of items such as expendables and oils and automotive parts designated by law as periodic automobile inspection items are recorded, at least in a corresponding relationship to the traveled distance of the automobile; a second storage device having an automobile management table which, for each user registered with the service, stores data about items such as expendables and oils and automotive parts to be inspected that match the model and type of the user's automobile, along with maintenance and repair history thereof; an input device for inputting the total distance so far traveled by the user's automobile and storing data thereof in the automobile management table each time the automobile travels a predetermined distance or each time the automobile undergoes maintenance or inspection at a service factory; and a determining device which searches the automobile management table based on the stored traveled-distance information and determines whether or not there is any part that needs checking or any item that needs servicing or replacing, wherein when it is determined that there is a part that needs checking or a item that needs servicing or replacing, the determining device notifies the automobile user accordingly.

In a system according to a second aspect which refers back to the system of the first aspect, the automobile management table also stores information such as the address and contact number of the user, the model name, type, and model year of the automobile, and the name and address of a dealer where the automobile was purchased.

In a system according to a third aspect which refers back to the system of the second aspect, if there is any part that needs checking or any item that needs servicing or replacing, the determining device searches the automobile management table once again to check whether there is any other part or item for which checking, servicing, or replacement timing is expected to arrive within a predetermined travel distance as counted from current total distance traveled, and sends information including the result of the search to the contact number of the automobile user.

In a system according to a fourth aspect which refers back to the system of the second or third aspect, the system further comprises a third storage device having a nationwide maintenance site management table in which information concerning maintenance sites is stored along with information describing automobile inspection and maintenance items and the capability of each individual maintenance site to perform automobile maintenance or repair that matches each automobile model or type, wherein: if there is any part that needs checking or any item that needs servicing or replacing in the user's automobile, the determining device sends an inquiry to the contact number of the user, inquiring whether the user desires to have the automobile checked and serviced, and if the user desires to have the automobile checked and serviced, the determining device searches the maintenance site management table for a maintenance site that can perform the needed maintenance or repair, and sends information about the maintenance site searched for to the contact number of the automobile user.

In a system according to a fifth aspect which refers back to the system of the fourth aspect, if a response is received from the automobile user desiring to have the automobile checked and serviced, the determining device sends a further inquiry to the contact number of the user, inquiring whether the user desires to have the automobile checked and serviced immediately; if a response is received from the user desiring to have the automobile checked and serviced immediately, the determining device detects current position of the automobile; the determining device makes a search through the automobile management table within a predetermined distance range from the current position of the automobile to locate a nearby maintenance site that can perform the inspection and maintenance of the automobile, and sends information about the located maintenance site to the contact number of the automobile user; if a response is received from the user desiring to have the automobile checked and serviced but not immediately, the determining device searches the maintenance site table based on the address of the user; and the determining device retrieves information about a maintenance site located within a predetermined distance range from the address of the user and capable of performing the inspection and maintenance of the automobile, and sends the information to the contact number of the automobile user.

In a system according to a sixth aspect which refers back to the system of one of the first to fifth aspects, the total distance traveled by the automobile is entered into the automobile management table at a filling station each time the automobile stops for refueling.

According to the automobile failure prevention support service method and system, the inspection and maintenance of the automobile is performed, not at predetermined intervals of time, but according to the degree of deterioration of expendable parts, etc. related to the traveled distance of the automobile. As a result, not only can effective and economical utilization of the automobile be achieved, but also the occurrence of a public nuisance such as air pollution by exhaust gas emissions can be prevented; furthermore, provisions are made to be able to even notify the user of the automobile of the site where the necessary inspection and maintenance can be received.

Further, according to the automobile failure prevention support service method and system, provisions are made to notify the owner of the automobile of the maintenance timing based on the degree of deterioration of expendable parts, etc. related to the traveled distance of the automobile, and to provide useful information to the user, for example, recommending a service factory, in accordance with a “maintenance needed/not needed response” from the notified user; this serves to enhance the user's convenience.

Furthermore, according to the automobile failure prevention support service method and system, when notifying the user of the presence of the part or parts that need servicing, it is also checked whether there is any other part that will need servicing in the near future and, if there is any such part, the user of the automobile is also notified of the presence of such a part; this serves to reduce the number of times the user has to receive maintenance and the cost involved.

### BRIEF DESCRIPTION OF THE DRAWINGS

The above and other objects, features, and advantages of the invention will be described in detail below with reference to preferred embodiments, taken in conjunction with the accompanying drawings in which:

FIG. 1 is a diagram showing the entire configuration of an automobile failure prevention support service system according to the present invention;

FIG. 2 is a diagram showing one example of the contents of a user master table maintained in a service center shown in FIG. 1;

FIG. 3 is a diagram showing one example of an automobile status master table within the user master table maintained in the service center shown in FIG. 1;

FIG. 4 is a diagram showing one example of a hierarchized expendable part check table within a maintenance site management table maintained in the service center shown in FIG. 1;

FIG. 5 is a diagram showing one example of a basic failure mater table for an automobile, which corresponds to the lowest hierarchical level in the expendable part checkup table shown in FIG. 4;

FIG. 6 is a diagram showing one example of the contents of a check item description master table within the maintenance site management table maintained in the service center shown in FIG. 1;

FIG. 7 is a diagram for explaining one example of a hierarchized maintenance site master table in which maintenance sites are recorded, and which is contained in the maintenance site management table maintained in the service center shown in FIG. 1;

FIG. 8 is a diagram for explaining one example of the contents of the lowest hierarchical level in the maintenance site master table shown in FIG. 7;

FIG. 9 is a diagram showing one example of the description of check codes and repair details at a particular maintenance site in the maintenance site master table shown in FIG. 8;

FIG. 10 is a flowchart for explaining a procedure for user registration with the service center;

FIG. 11 is a flowchart for explaining a procedure for parts failure prevention processing in an automobile failure prevention support service method according to the present invention;

FIG. 12A is a flowchart for explaining another example of the procedure for parts failure prevention processing in the automobile failure prevention support service method according to the present invention;

FIGS. 12B and 12C are diagrams each showing one example of a screen for inquiring a user about maintenance;

FIG. 13 is a flowchart showing one example of a procedure performed to present recommended maintenance sites to the user;

FIG. 14 is a diagram showing one example of a screen for presenting a list of recommended maintenance sites to the user; and

FIG. 15 is a flowchart showing one example of a procedure when reserving a maintenance site in response to a request from the user.

### BEST MODE FOR CARRYING OUT THE INVENTION

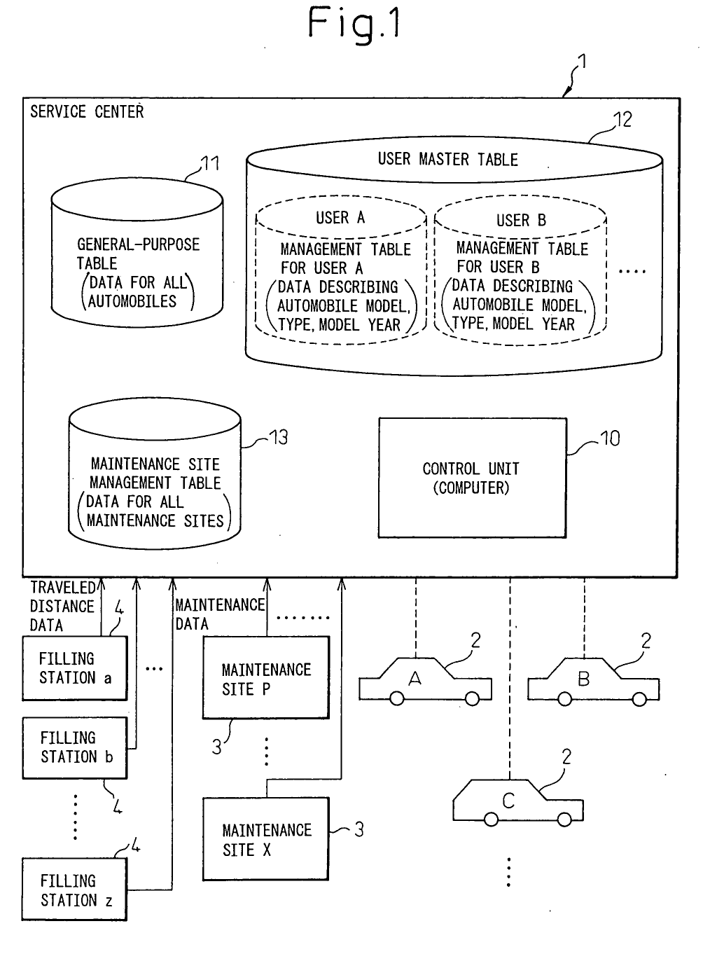

FIG. 1 is a diagram showing the entire configuration of an automobile failure prevention support service system according to the present invention. The system of the present invention comprises a service center 1, automobiles 2 of users registered with the service center 1, a plurality of maintenance sites 3, and a plurality of filling stations 4. The maintenance sites 3 and the filling stations 4 are registered with the service center 1 on a nationwide scale.

It is desirable that a single service center 1 be established on a nationwide scale, but in a case where a petroleum company that runs filling stations 4 has its own service center 1, it is desirable to construct the system as if there is only one service center 1 by interlinking the service centers 1 of the respective companies via an information communication mechanism such as the Internet and allowing them to share data about the users and the users' automobiles via the information communication mechanism.

The service center 1 contains a general-purpose table 11, a user master table 12, a maintenance site management table 13, and a control unit 10 using a computer for processing data stored in the tables 11, 12, and 13. The general-purpose table 11 stores data about all automobiles of all makes, including foreign makes, that are designed to be driven on public roads; when a user registers his automobile with the service center 1, data about the user's automobile is retrieved from the general-purpose table 1 and stored in a table specific to the registered user. The user master table 12 stores data about all the users registered with the service center 1 along with data about the registered users' automobiles, and contains one automobile management table for each user. The maintenance site management table 13 stores data about the maintenance sites 3 and the filling stations 4 registered with the service center 1 on a nationwide basis, and also stores such data as expendable parts used in each automobile and for parts that need checking.

From each maintenance site 3, maintenance information of the automobile 2 and data about the traveled distance of the automobile 2, recorded at the time of maintenance, are transmitted to the service center 1. When a registered user's automobile is refueled at a filling station 4, data about the traveled distance of the automobile is transmitted from the filling station 4 to the service center 1. When a minor maintenance is performed at the filling station 4, maintenance data is also transmitted to the service center 1.

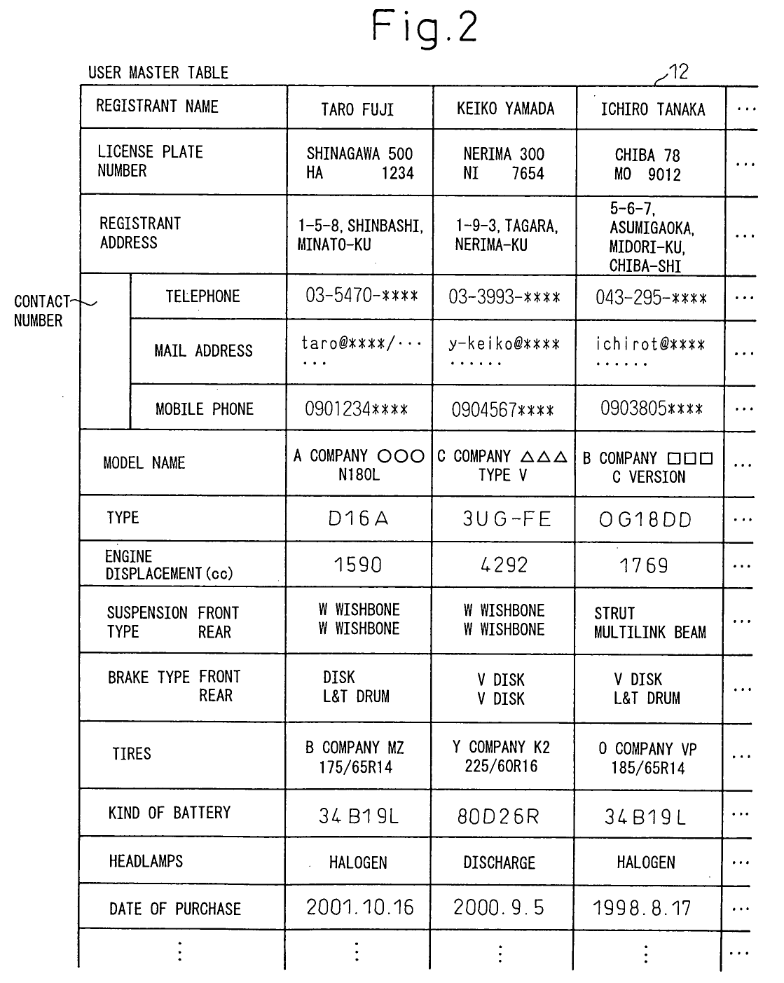

FIG. 2 shows one example of the contents of the user master table 12 maintained in the service center 1 shown in FIG. 1. The user master table 12 stores data for each registered user in the form of a table in which are recorded such data items as registrant name, license plate number, registrant address, model name and type of registrant's automobile, engine displacement volume, type of suspension, type of brakes, kind of tires, kind of mounted battery, type of headlamps, and purchase date of automobile.

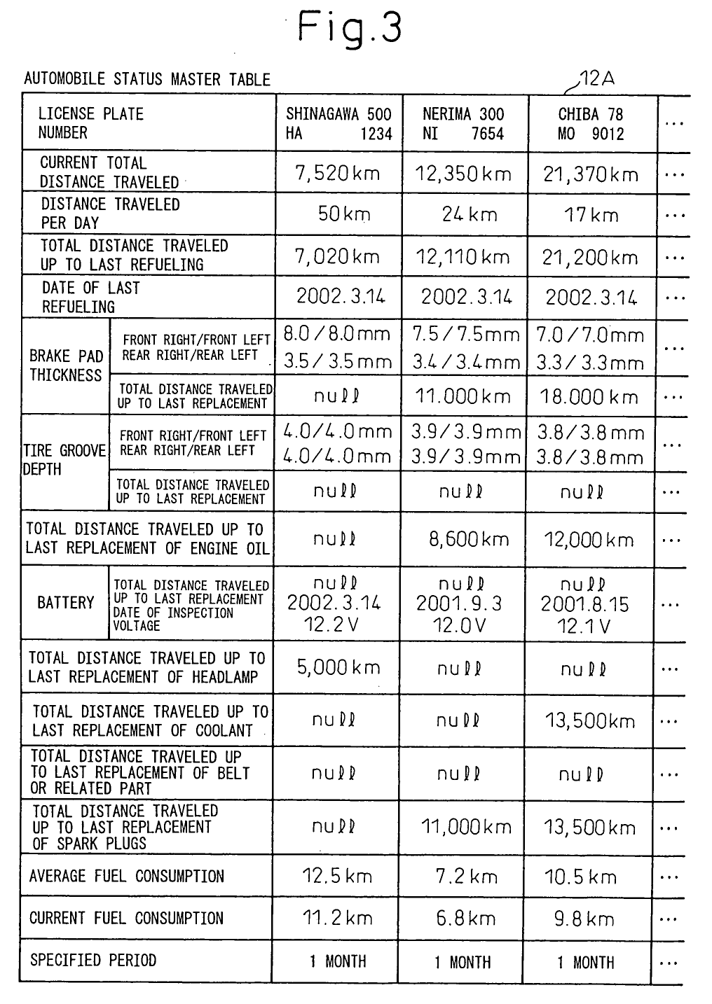

FIG. 3 shows one example of an automobile status master table 12A within the user master table 12 maintained in the service center 1 shown in FIG. 1. The automobile status master table 12A stores various kinds of data for each automobile in relationship to the automobile's license plate number stored in the user master table 12. In the automobile status master table 12A are recorded such data items as current total distance traveled, average distance traveled per day, total distance traveled up to last refueling, date of last refueling, total distance traveled up to replacement of each expendable part, average fuel consumption, current fuel consumption, specified period, etc. Though not shown here, date of replacement of each expendable part may also be recorded. The average distance traveled per day is computed by calculation from the current total distance traveled and the number of days elapsed from the purchase date of the automobile. The current fuel consumption is computed from the distance traveled as the date of refueling to the date of next refueling and the amount of refueling, while the average fuel consumption is computed from the total fuel consumption in the past.

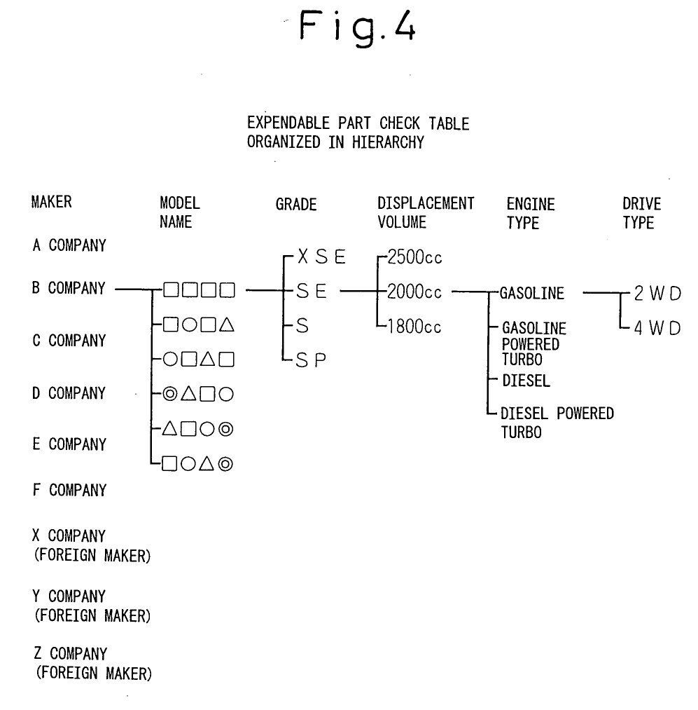

FIG. 4 shows one example of a hierarchized expendable part check table within the maintenance site management table 13 maintained in the service center 1 shown in FIG. 1. To check an expendable part, the automobile in which the expendable part is used must be identified. Therefore, to enable each automobile to be identified, the check table is organized in a hierarchical manner; for example, automobile manufacturers are at the highest level of the hierarchy, under which automobile model name, grade name, displacement volume, engine type, are drive type are arranged in this order in the hierarchy. FIG. 4 shows by way of example the hierarchy for identifying automobiles manufactured by Company B.

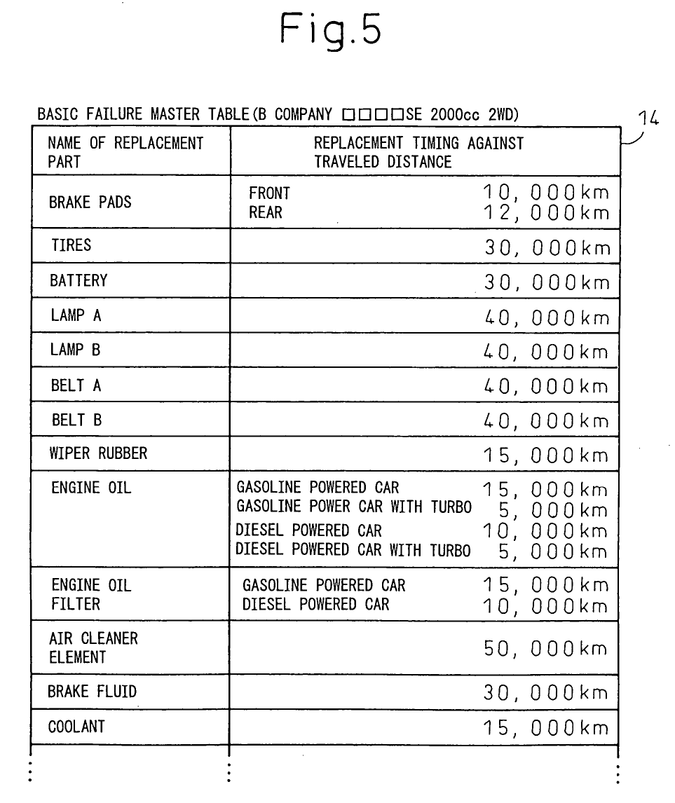

FIG. 5 shows one example of a basic failure master table 14 for an automobile, which corresponds to the lowest hierarchical level in the expendable part check table shown in FIG. 4. In the illustrated table, the names of replacement parts for Company B's model □□□□SE, 2000-cc gasoline-powered automobile whose drive type is 2WD are shown along with recommended replacement timing in terms of the distance traveled. Each traveled distance shown as the recommended replacement timing in this table 14 is only illustrative and does not represent an actual figure.

If the number of days elapsed from the date of last replacement is preferable to the traveled distance as the recommended replacement timing, the number of days elapsed from the date of last replacement may be recorded here.

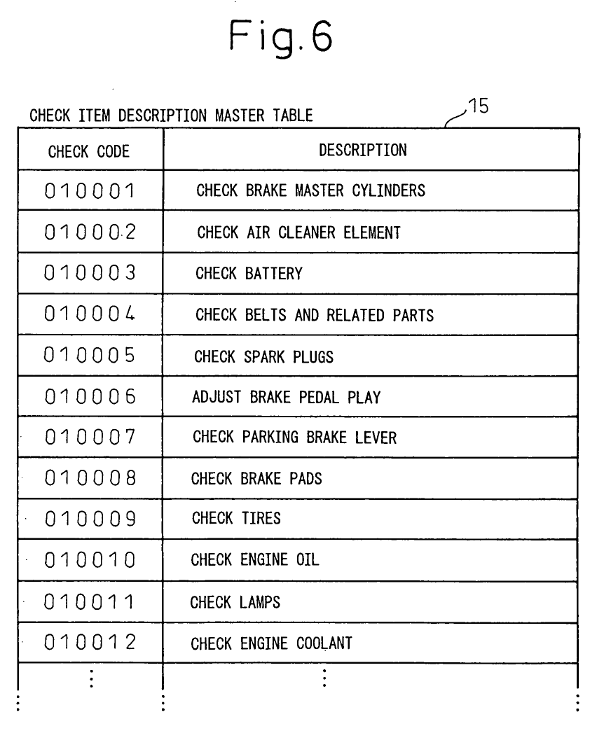

FIG. 6 shows one example of the contents of a check item description master table 15 within the maintenance site management table 13 maintained in the service center 1 shown in FIG. 1. In this table 15, a check code is assigned to each check item.

The tables shown in FIGS. 4 and 6 may be maintained at each maintenance site 3.

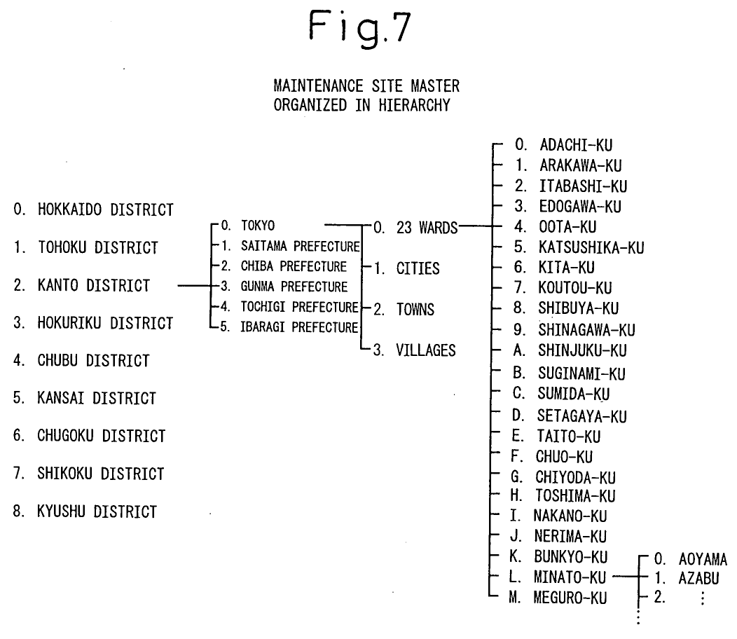

FIG. 7 is a diagram for explaining one example of a hierarchized maintenance site master table in which maintenance sites are recorded, and which is contained in the maintenance site management table 13 maintained in the service center 1 shown in FIG. 1. As the maintenance sites are registered on a nationwide scale, the table must be organized in a hierarchy so that any specific maintenance site can be located by searching through the table. Japan is divided into nine districts which are shown at the highest level of the hierarchy, and the names of prefectures belonging to each district are listed at the next level of the hierarchy, followed by the hierarchical level where each prefecture is divided into ward, city, town, and village categories, under which the hierarchical level designating the names of wards, cities, towns, and villages and the hierarchical level designating the names of areas are arranged in this order.

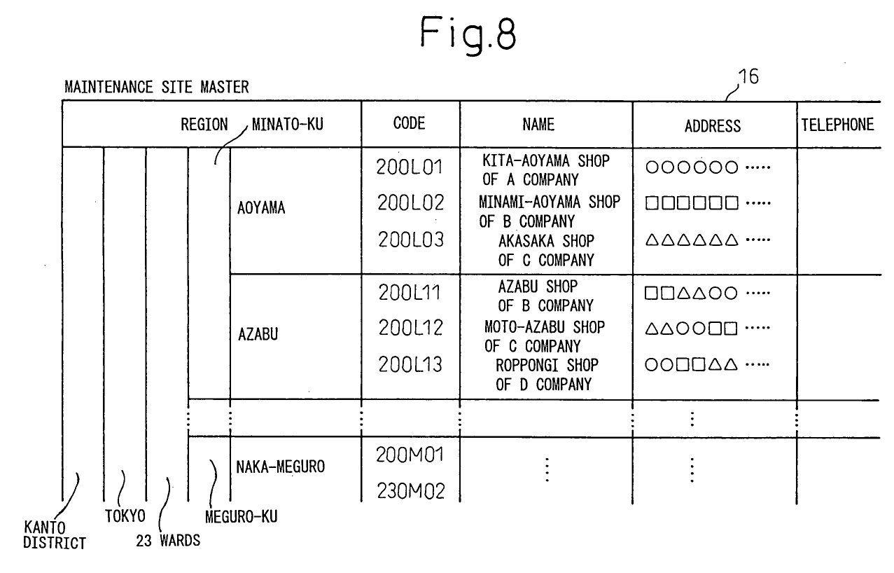

FIG. 8 is a diagram for explaining one example of the contents of the lowest hierarchical level in the maintenance site master table shown in FIG. 7. This diagram shows the data for the Aoyama and Azabu areas (designated by 0 and 1, respectively) in the Minato Ward (designated by L) in Tokyo (designated by 0) in the Kanto district (designed by 2). The maintenance site master table 16 shown in FIG. 8 is obtained by entering (200L0) in accordance with the hierarchy shown in FIG. 7.

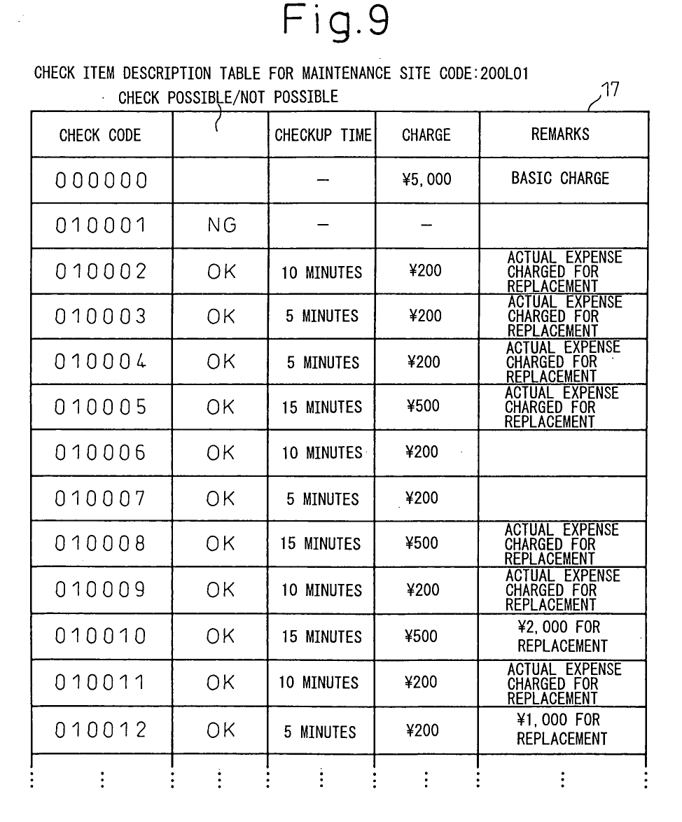

FIG. 9 shows a check item description table 17 for the maintenance site designed by the code (200L01) in the maintenance site master table 16 shown in FIG. 8. This check item description table 17 carries such data as repair possible/not possible, checkup time, charge, etc. for each check code shown in FIG. 6. When the check items are determined in advance, the total amount of charge for the checks to be performed at this maintenance site can be calculated from the contents of this check item description table 17.

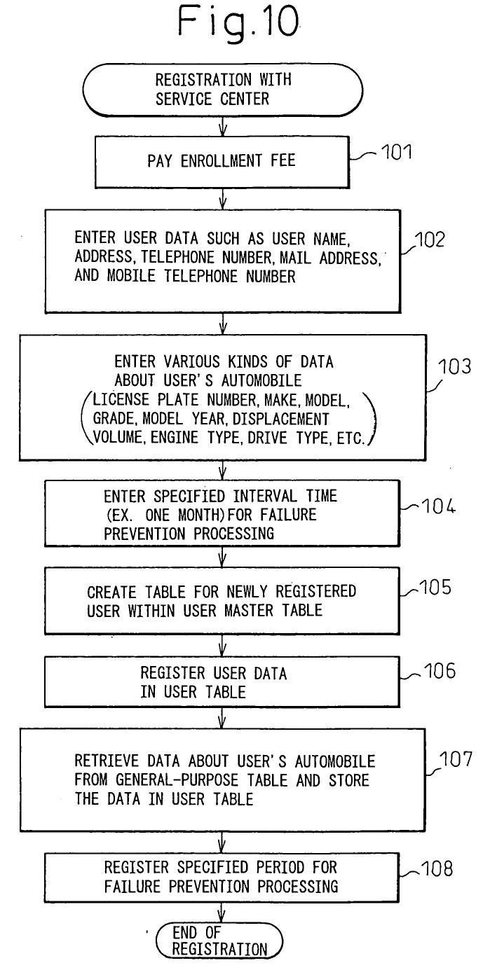

Next, one example of the automobile failure prevention support service method used in the above-configured automobile failure prevention support service system will be described with reference to FIGS. 10 to 15.

FIG. 10 is a flowchart for explaining a procedure for user registration with the service center 1. The automobile failure prevention support service system of the present invention comprises, as previously described, the service center 1, the automobiles 2 of the users registered with the service center 1, the plurality of maintenance sites 3, and the plurality of filling stations 4. Accordingly, the user of an automobile who desires to receive the service of the present invention must first register with the service center 1.

In step 101, the user pays an enrollment fee for registration with the service center 1. Then, in step 102, the user enters user data such as user name, address, telephone number, mail address, and mobile telephone number. After entering the user data, the user in step 103 enters various kinds of data about the user's automobile. The various kinds of data include, for example, the license plate number, make, model, grade, model year, displacement volume, engine type, drive type, etc. of the automobile. After entering the data, the user in step 104 enters the specified period for failure prevention processing. The specified period is, for example, one month; that is, when a replacement part that needs checking is found in the failure prevention processing, a further search is made to see whether there is any other replacement part that will need checking within this specified period.

When the user has entered the data as described above, then in step 105 the service center 1 creates a folder for this newly registered user within the user master table 12, and creates a user table in that folder. Then, in step 106, the user data is registered in this table, and in the next step 107, data about the user's automobile is retrieved from the general-purpose table 11 and stored in the user table. In the final step 108, the specified period for the failure prevention processing is registered in the user table, to complete the user registration with the service center 1.

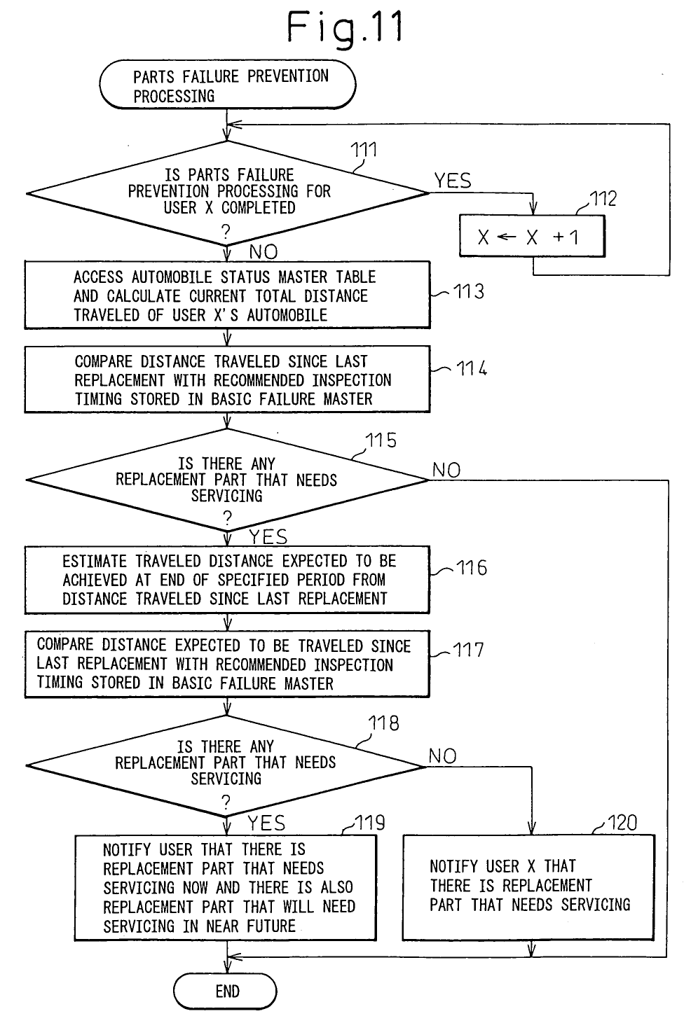

FIG. 11 is a flowchart for explaining the procedure of parts failure prevention processing in the automobile failure prevention support service method of the present invention performed for the user registered with the service center 1 in the procedure of FIG. 10. This processing is performed for all registered users at every predetermined time interval, for example, once every day.

In step 111, it is determined whether the failure prevention processing for user X is completed or not. Here, X is the user number. When the failure prevention processing for user X is completed, the process proceeds to step 112 to increment the user number X by 1, and the same processing is performed for the next user.

When the failure prevention processing for user X is not completed, the process proceeds to step 113, and the current total distance traveled of the user X's automobile is calculated by accessing the automobile status master table 12A. The current total distance traveled can be obtained by multiplying the average distance traveled per day by the number of days elapsed from the date of the last refueling and adding the product to the total traveled distance recorded at the time of the last refueling.

After calculating the current total distance traveled in this way, the distance traveled after the last replacement is calculated in step 114 from the current total distance traveled, and the calculated distance is compared with the recommended inspection (replacement) timing stored in the basic failure master table 14. Here, if the recommended inspection (replacement) timing in the basic failure master table 14 is determined in terms of the number of days elapsed from the date of the last replacement, the number of days elapsed between the date of the last replacement and the current date is compared with the recommended inspection timing. In step 115, it is determined whether there is any replacement part that needs servicing, by referring to the recommended inspecting timing against the distance traveled since the last replacement. If it is determined in step 115 that there is no replacement part that needs servicing, the routine is terminated without performing further processing.

On the other hand, if it is determined in step 115 that there is a replacement part that needs servicing, the process proceeds to step 116, where the traveled distance expected to be achieved at the end of the specified period (for example, one month) is estimated from the distance traveled since the last replacement. The estimated traveled distance can be obtained by multiplying the average distance traveled per day by 30 and adding the product to the current total distance traveled.

After thus calculating the estimated traveled distance, the distance expected to be traveled after the last replacement is calculated in step 117, and compared with the recommended inspection timing stored in the basic failure master table 14. Here, as in step 114, there are cases where the number of days elapsed between the date of the last replacement and the current date is compared with the recommended inspection timing. In step 118, it is determined whether there is any replacement part that needs servicing, by referring to the recommended inspection timing against the distance expected to be traveled since the last replacement. If it is determined in step 118 that there is no replacement part that will need servicing within the one month period, the process proceeds to step 120 to notify the user X that there is a replacement part that needs servicing now, and the failure prevention processing for the user X is terminated, thus terminating the routine.

On the other hand, if it is determined in step 118 that there is a replacement part that will need servicing within the one month period, the process proceeds to step 119 to notify the user X that there is a replacement part that needs servicing now and there is also a replacement part that will need servicing in the near future, and the failure prevention processing for the user X is terminated, thus terminating the routine.

Since the user X is notified as described above of the arrival of the replacement time for parts in accordance with the traveled distance of the automobile, the user can accurately know the inspection/maintenance timing of his automobile even if he has little knowledge about automobiles.

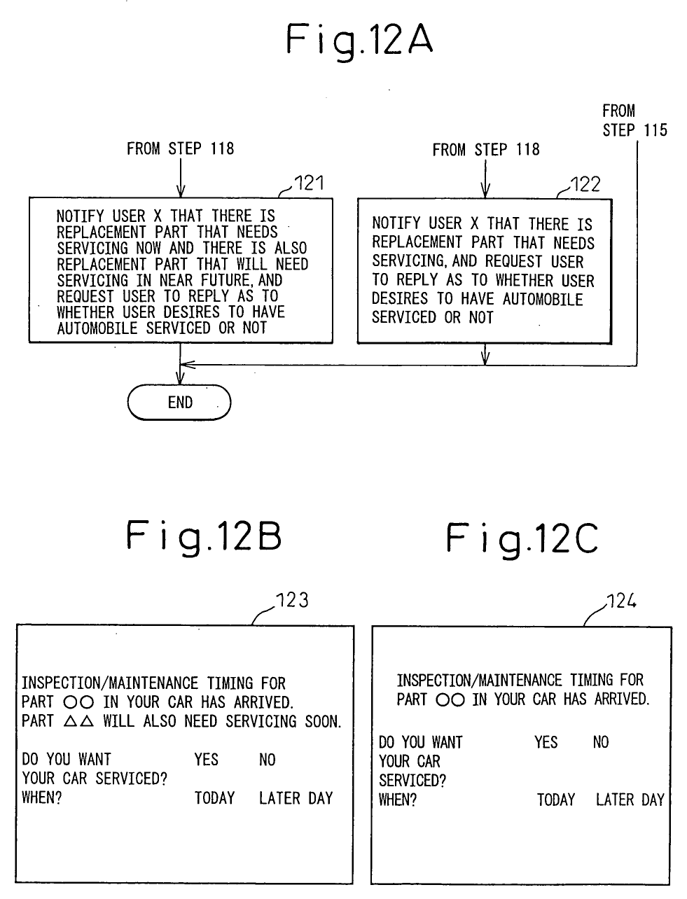

In the above embodiment, in step 119 or 120 the user is simply notified that there is a replacement part that needs servicing, but when notifying the user, an inquiry may also be made to the user as to whether he desires to have his automobile serviced. An embodiment implementing this is shown in FIG. 12A. Steps 111 to 118 in the procedure of this embodiment are exactly the same as the corresponding steps in the procedure shown in FIG. 11; therefore, these steps will not be shown or described, and only the difference will be described here.

In step 121 which replaces step 119, after notifying the user X that there is a replacement part that needs servicing now and there is also a replacement part that will need servicing in the near future, a screen 123 such as shown in FIG. 12B is displayed on the user's mobile telephone or personal computer, inquiring whether he desires to have his automobile serviced and, if yes, then when. On the other hand, in step 122 which replaces step 120, after notifying the user X that there is a replacement part that needs servicing now, a screen 124 such as shown in FIG. 12C is displayed on the user's mobile telephone or personal computer, inquiring whether he desires to have his automobile serviced and, if yes, then when.

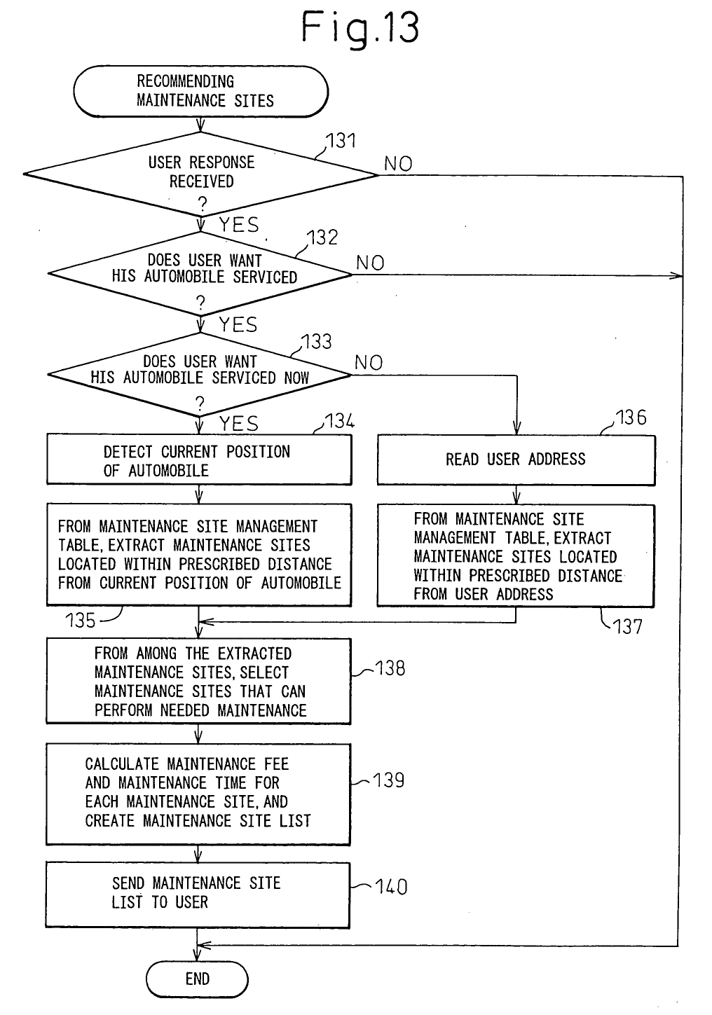

FIG. 13 shows one example of a procedure performed to present recommended maintenance sites to the user when the user responded to the inquiry in step 121 or 122 in FIG. 12A. In step 131, it is determined whether there is a response from the user, and if no response, the routine is terminated; on the other hand, if there is a response, the process proceeds to step 132.

In step 132, it is determined whether the user has responded that he desires to have his automobile serviced; if the user has responded that he does not desire to have his automobile serviced, the routine is terminated without performing further processing, but if the user has responded that he desires to have his automobile serviced, the process proceeds to step 133. In step 133, it is determined whether the user desires to have his automobile serviced now or at a later date. If the user desires to have his automobile serviced now, the process proceeds to step 134 to detect the current position of the automobile.

If the automobile is equipped with a navigation system, the current position of the automobile is obtained by transmitting the position detected by the navigation system to the service center 1 via the mobile telephone. With the mobile telephone alone, a rough position of the automobile can be detected from the location of the base station currently serving the user's mobile telephone.

In step 135, the control circuit 10 in the service center 1 searches the maintenance site management table 13 and extracts a plurality of maintenance sites located within a prescribed distance from the detected current position of the automobile.

On the other hand, if, in step 133, the user has responded that he desires to have his automobile serviced at a later date, the process proceeds to step 136 to retrieve the user address from the user master table 12. Then, in step 137, the control circuit 10 in the service center 1 searches the maintenance site management table 13 and extracts a plurality of maintenance sites located within a prescribed distance from the user's address.

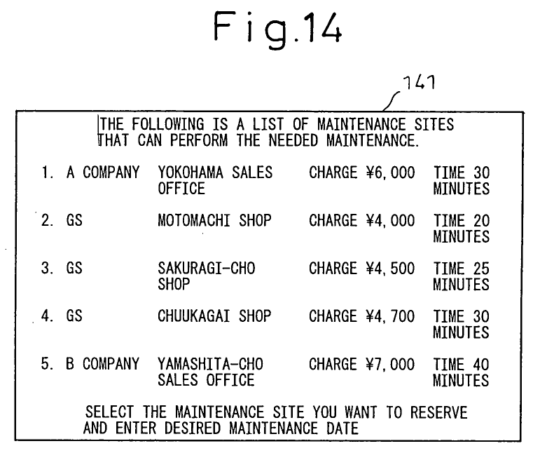

When the maintenance sites are extracted in step 135 or 137, maintenance sites that can perform the maintenance reported in step 121 or 122 are selected in step 138 from among the extracted maintenance sites. Then, in step 139, maintenance fee and maintenance time are calculated for each maintenance site, and a list of maintenance sites is created. This maintenance site list is displayed as shown on a screen 141 in FIG. 14. The list is also displayed with a prompt requesting the user to reserve the maintenance site of his choice and enter the desired maintenance date. In step 140, the list is transmitted for display on the user's mobile telephone or personal computer, after which the routine is terminated.

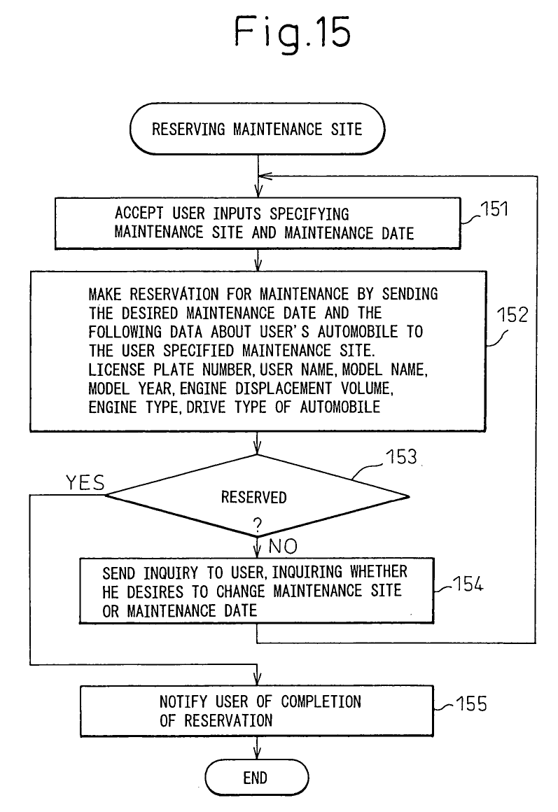

FIG. 15 shows one example of a procedure when reserving a maintenance site in response to a request from the user. In step 151, user inputs specifying the maintenance site and maintenance date are accepted, and in the next step 152, the desired maintenance date and various kinds of data about the user's automobile (including information concerning the parts that need servicing) are transmitted to the user specified maintenance site to make a reservation for the maintenance. The various kinds of data include, for example, the license plate number, user name, model name, model year, engine displacement volume, engine type, drive type, etc. of the automobile. When the user has responded in step 133 that he desires to have his automobile serviced now, the present time and date is automatically displayed on the input screen, allowing the user to make a reservation by checking the display.

In step 153, it is determined whether the reservation of the maintenance site has been made successfully; if the answer is yes, the process proceeds to step 155 to notify the user of the completion of the reservation, after which the routine is terminated. On the other hand, if, in step 153, the reservation of the maintenance site cannot be made, the process proceeds to step 154, and an inquiry is sent to the user, inquiring whether he desires to change the maintenance site or the maintenance date. After that, the procedure from step 151 to step 153 is repeated until the reservation is successfully made.

With the above procedure, the automobile user, once registered with the service center 1, need not worry about the condition of his automobile but need only respond to the instructions of the service center 1 only when a notification is received from the center 1. As a result, even if the user has little knowledge about automobiles, the user can keep his automobile in a trouble-free condition. Further, as the service center 1 makes arrangements for the maintenance of the automobile, the user can receive the inspection and maintenance service at a time convenient for him. Moreover, when the service center 1 makes arrangements for the maintenance, as the maintenance site is notified in advance of the maintenance requiring parts, the maintenance time can be shortened.

When the system with the service center 1 as its core is operated by an automobile manufacturer, the manufacturer can keep their customers loyal through the operation of the system. While the service method and system of the present invention is particularly effective for automobiles, the invention can also be applied, for example, to the failure prevention of electric appliances, such as personal computers, whose internal mechanisms are not easy for users to understand.

Potential for Exploitation in Industry

According to the automobile failure prevention support service method and system described in the present invention, since periodic inspection and maintenance can be performed in accordance with the actual degree of deterioration of expendable parts related to the traveled distance of the automobile, not only can the effective and economical utilization of the automobile be achieved, but also a public nuisance such as air pollution caused by exhaust gas emissions can be prevented.

Further, the automobile failure prevention support service method and system described in the present invention can notify the owner of the automobile of the arrival of the maintenance time based on the degree of deterioration of expendable parts related to the traveled distance of the automobile, and can provide useful information to the user, for example, recommending a service factory, in accordance with a “maintenance needed/not needed” response from the notified user; this is particularly effective in enhancing the user's convenience.

Furthermore, when a part that needs servicing is found, any other part that will need servicing in the near future within the specified period is also presented to the user; this serves to save the user the trouble of visiting the maintenance site repeatedly, and the maintenance cost can thus be reduced.

1. An automobile failure prevention support service method for providing support for prevention of automobile failures, wherein:
a general-purpose table is created which stores the degrees of deterioration of automotive parts and expendables in corresponding relationship to maintenance timing;
an automobile management table specific to each user registered with the service is created which stores data about parts and expendables of the user's automobile along with a maintenance history thereof;
a determination is made as to whether or not there is any part that needs checking or any item that needs servicing or replacing, by checking the automobile management table against the general-purpose table based on the stored maintenance history; and
if there is any part that needs checking or any item that needs servicing or replacing in the user's automobile, the user of the automobile is notified accordingly.

2. An automobile failure prevention support service method as claimed in claim 1, wherein
the automobile management table also stores information such as the address and contact number of the user, the model name, type, and model year of the automobile, and the name and address of a dealer where the automobile was purchased.

3. An automobile failure prevention support service method as claimed in claim 2, wherein
if there is any part that needs checking or any item that needs servicing or replacing, the automobile management table is searched once again to check whether there is any other part or item for which checking, servicing, or replacement time is expected to arrive within a predetermined travel distance as counted from current total distance traveled, and
information including the result of the search is sent to the contact number of the automobile user.

4. An automobile failure prevention support service method as claimed in claim 2, wherein:
a maintenance site management table is further created which stores information concerning maintenance sites on a nationwide scale along with information describing automobile inspection and maintenance items and the capability of each individual maintenance site to perform automobile maintenance or repair that matches each automobile model or type;
if there is any part that needs checking or any item that needs servicing or replacing in the user's automobile, an inquiry is sent to the contact number of the user, inquiring whether the user desires to have the automobile checked and serviced;
if the user desires to have the automobile checked and serviced, a search is made for a maintenance site that can perform the needed maintenance or repair; and
information about the maintenance site searched for is sent to the contact number of the automobile user.

5. An automobile failure prevention support service method as claimed in claim 4, wherein:
if a response is received from the automobile user desiring to have the automobile checked and serviced, a further inquiry is sent to the contact number of the user, inquiring whether the user desires to have the automobile checked and serviced immediately;
if a response is received from the user desiring to have the automobile checked and serviced immediately, the current position of the automobile is detected;
a search is made through the automobile management table within a predetermined distance range from the current position of the automobile to locate a nearby maintenance site that can perform the inspection and maintenance of the automobile, and information about the located maintenance site is sent to the contact number of the automobile user;
if a response is received from the user desiring to have the automobile checked and serviced but not immediately, a table in which maintenance sites are stored in association with the address of the user is referred to; and
a search is made for a maintenance site located within a predetermined distance range from the address of the user and capable of performing the inspection and maintenance of the automobile, and information about the maintenance site searched for is sent to the contact number of the automobile user.

6. An automobile failure prevention support service method as claimed in any one of claim 1, wherein
the maintenance history of the automobile is entered into the automobile management table at a filling station each time the automobile stops for refueling or at a maintenance site at which the maintenance has been performed.

7. An automobile failure prevention support service system for providing support for prevention of automobile failures to users registered with a service center, comprising:
an intercommunication mechanism interlinking the service center, automobile maintenance and repair sites, and the registered users;
a first storage device having a general-purpose table in which, for each automobile model and type, the degrees of deterioration of items such as expendables and oils and automotive parts designated by law as periodic automobile inspection items are recorded, at least in a corresponding relationship to the traveled distance of the automobile;
a second storage device having an automobile management table which, for each user registered with the service, stores data about items such as expendables and oils and automotive parts to be inspected that match the model and type of the user's automobile, along with maintenance and repair history thereof;
an input device for inputting the total distance so far traveled by the user's automobile and storing data thereof in the automobile management table each time the automobile travels a predetermined distance or each time the automobile undergoes maintenance or inspection at a service factory; and
a determining device which searches the automobile management table based on the stored traveled-distance information and determines whether or not there is any part that needs checking or any item that needs servicing or replacing, wherein
when the determining device determines that there is a part that needs checking or a item that needs servicing or replacing, the determining device notifies the automobile user accordingly.

8. An automobile failure prevention support service system as claimed in claim 7, wherein
the automobile management table also stores information such as the address and contact number of the user, the model name, type, and model year of the automobile, and the name and address of a dealer where the automobile was purchased.

9. An automobile failure prevention support service system as claimed in claim 8, wherein
if there is any part that needs checking or any item that needs servicing or replacing, the determining device searches the automobile management table once again to check whether there is any other part or item for which a checking, servicing, or replacement time is expected to arrive within a predetermined travel distance as counted from current total distance traveled, and sends information including the result of the search to the contact number of the automobile user.

10. An automobile failure prevention support service system as claimed in claim 8, further comprising:
a third storage device having a nationwide maintenance site management table in which information concerning maintenance sites is stored along with information describing automobile inspection and maintenance items and the capability of each individual maintenance site to perform automobile maintenance or repair that matches each automobile model or type, and wherein:
if there is any part that needs checking or any item that needs servicing or replacing in the user's automobile, the determining device sends an inquiry to the contact number of the user, inquiring whether the user desires to have the automobile checked and serviced, and
if the user desires to have the automobile checked and serviced, the determining device searches the maintenance site management table for a maintenance site that can perform the needed maintenance or repair, and sends information about the maintenance site searched for to the contact number of the automobile user.

11. An automobile failure prevention support service system as claimed in claim 10, wherein;
if a response is received from the automobile user desiring to have the automobile checked and serviced, the determining device sends a further inquiry to the contact number of the user, inquiring whether the user desires to have the automobile checked and serviced immediately;
if a response is received from the user desiring to have the automobile checked and serviced immediately, the determining device detects the current position of the automobile;
the determining device makes a search through the automobile management table within a predetermined distance range from the current position of the automobile to locate a nearby maintenance site that can perform the inspection and maintenance of the automobile, and sends information about the located maintenance site to the contact number of the automobile user;
if a response is received from the user desiring to have the automobile checked and serviced but not immediately, the determining device searches the maintenance site table based on the address of the user; and
the determining device retrieves information about a maintenance site located within a predetermined distance range from the address of the user and capable of performing the inspection and maintenance of the automobile, and sends the information to the contact number of the automobile user.

12. An automobile failure prevention support service system as claimed in any one of claim 7, wherein
the total distance traveled by the automobile is entered into the automobile management table at a filling station each time the automobile stops for refueling.
